(19) United States
(12) Patent Application Publication
(10) Pub. No.: US 2012/0310860 A1
(43) Pub. Date: Dec. 6, 2012

(54) Cloud-Based Demand Response

(75) Inventors: Hongseok Kim, Chatham, NJ (US); Young Jin Kim, Basking Ridge, NJ (US); Marina Thottan, Westfield, NJ (US)

(73) Assignee: Alcatel-Lucent, Murray Hill, NJ (US)

(21) Appl. No.: 13/153,741

(22) Filed: Jun. 6, 2011

(51) Int. Cl. G06Q 30/08

(52) U.S. Cl. 705/412

(57) ABSTRACT

Methods, systems, and apparatus for implementing cloud-based demand response are provided. Cloud-based demand response may be performed by publishing a demand response request at a communications node, the published demand response request including at least a load reduction request and an incentive price; initiating a load reduction bidding process in response to the published demand response request, the load reduction bidding process being accessible to customer nodes; and determining an updated incentive price based on at least one load reduction bid received from the customer nodes. The updated incentive price may be determined by a bisection function, and the at least one load reduction bid may be autonomously generated based on a customer cost function.

### FIELD OF THE INVENTION

The present invention is generally directed to cloud-based demand response for a smart power grid.

### BACKGROUND

Although the current power grid is one of the great engineering achievements of the last century, it is already very old. The aged power grid has been known as one of the main causes for frequent power disruption. Hence, there is a desire to transform the old power grid into a new “smart” power grid, which is expected to improve the quality, reliability, security and efficiency of the power grid.

One important consideration for a power grid is to balance the supply and demand of electricity at any instance. The stability of the power grid is threatened if either demand exceeds supply, or supply exceeds demand. Therefore, power generation must follow load accurately to prevent power disruption and cascading grid failures. For example, peak demand periods during hot summer months are a serious concern to utility providers, because expensive, stand-by generators must be used to maintain the stability of the power grid. These stand-by generators typically require high investment and running costs, either through operation or spot price purchases, and are mostly based on high-carbon resources.

Rather than increasing physical power generating facilities such as stand-by generators to meet demand requirements, a demand response mechanism that enables “virtual” power generation is being considered for smart power grids where electricity customers actively participate in balancing supply and demand. Demand response refers to changes in electrical usage by end-use customers from their normal consumption patterns in response to changes in the price of electricity over time, or to incentive payments designed to induce lower electricity use at times of high wholesale market prices or when system reliability is jeopardized.

Demand response can be seen as an optimization problem with virtual power generation being associated with some cost function (i.e., a function of input prices and output quantity); where the objective is to minimize the virtual power generation cost while satisfying actual power generation requirements. Hence, a utility region with a large number of customers can be considered a competitive demand response market. In a competitive demand response market, optimal demand response can be achieved by computing an optimal incentive price for market participants.

An iterative bidding process among end-use customers may be employed to compute an optimal incentive price. For example, demand response systems proposed so far have been based on a centralized, traditional master/slave architecture that requires direct management by the utility provider. A utility provider's energy management system (EMS) interacts directly with each customer's EMS unit, which manages the cost function calculation for each individual customer. In operation, the utility provider's EMS sends out an incentive price for a demand response request and receives biddings directly from the customer EMS units.

However, for demand response implemented on a large scale, such as on current Internet-protocol (IP) networks (i.e., outside of a utility provider's firewall), the aforementioned systems have several potential reliability and security problems. For example, master/slave networks are well known to be susceptible to “single point of failure” cyber attacks that can be used by attackers to collapse servers and deny service to customers or regions. Further, the number of customers is limited by the utility provider's server capacity and the round-trip time between the utility provider's EMS and the various customers. For demand response based on an iterative bidding process, the communication latency between the utility provider's EMS and faraway customers may make implementation burdensome or even impractical.

The method used by the utility to conduct the iterative process may also be critical. In particular, the convergence of the iterative process to an optimal incentive price should be fast enough to be used in a very short time scale. For example, in the event of a demand response request, the iterative process must be quick enough to maintain power grid stability or prevent a cascading failure.

There is also a question of privacy for end-use customers in direct connection to utility providers. For example, if the utility provider has direct access to the cost function of each customer, it may employ differential incentive pricing according to the characteristics of customers in a centralized way. From the utility provider's perspective, differential incentive pricing may reduce the total power purchasing cost, but it also reduces the profit incentive for customers and increases the societal power generation cost.

### SUMMARY OF THE INVENTION

An alternative cloud-based demand response system and method is proposed to address the above-mentioned issues. Specifically, a cloud-based demand response method may be implemented by publishing a demand response request at a communications node. The published demand response request may include at least a load reduction request and an incentive price, and may be based at least in part on electricity usage data collected from at least one customer. The method may be further implemented by initiating a load reduction bidding process in response to the published demand response request, the load reduction bidding process being accessible to customer nodes; and determining an updated incentive price based on at least one load reduction bid received from the customer nodes. In one embodiment, the updated incentive price is calculated based on a bisection function.

In accordance with various embodiments, the cloud-based demand response method further comprises determining whether the bidding process is feasible, publishing the updated incentive price, determining a time for stopping the bidding process based on the updated incentive price, and transmitting the updated incentive price to the electric utility provider.

In accordance with various embodiments, the cloud-based demand response method further comprises selecting an arbitrary node for determining the updated incentive price, wherein the arbitrary node may be a customer node or a specialized computing node.

These and other advantages of the invention will be apparent to those of ordinary skill in the art by reference to the following detailed description and the accompanying drawings.

### BRIEF DESCRIPTION OF THE DRAWINGS

FIG. 1 is a diagram showing an environment that may be used for implementing cloud-based demand response;

FIG. 2 is an exemplary diagram showing a cloud computing environment that may be used for implementing cloud-based demand response;

FIG. 3 is a flowchart showing the steps taken for implementing cloud-based demand response in a cloud computing environment;

FIG. 4 is a high-level block diagram of middleware that may be used for implementing cloud-based demand response on a network; and

FIG. 5 is a high-level block diagram of an exemplary computer that may be used for implementing cloud-based demand response.

### DETAILED DESCRIPTION

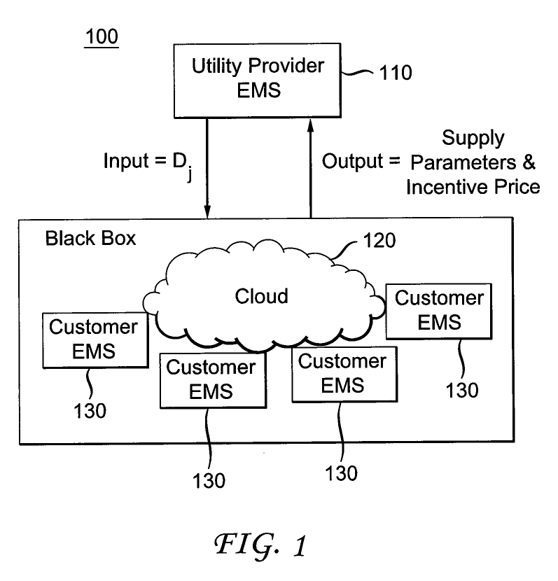

A cloud-based demand response (DR) system and method can provide demand response from end-use customers while minimizing the role of the utility provider. FIG. 1 illustrates an environment in which various embodiments of cloud-based demand response may be implemented. Cloud-based demand response may be implemented through a cloud computing environment 100 where, from an electric utility provider's point of view, load reduction requests appear to be fulfilled autonomously and remotely, such as within a computational black box. For example, when load reduction is necessary to maintain the stability of the power grid, the electric utility provider may input a request for a virtual power solution by communicating a demand response request from its energy management system (EMS) server 110 to the cloud 120.

The demand response request may include a load reduction request, determined by the amount of power the utility provider needs to balance the supply and demand in the power grid, and an incentive price range. The incentive price range comprises a maximum incentive price, that may be a function of the “spot” (physical power generation) market price for the particular utility region. For example, the spot market price may represent the price that the utility provider would have to pay to have remotely generated power delivered to the utility region, considering the additional costs for surcharges, transmission loss, distribution or the like. Alternatively, the maximum incentive price may be determined based on other criteria, such as the availability of alternative power sources, disaster management or weather predictions.

Within the black box, end-use customers are networked to the cloud 120 via nodes 130 comprising customer EMS units. As will be explained in further detail below, the customer EMS units may be adapted to autonomously calculate load reduction bids in response to a given demand response request. For example, a customer EMS unit 130 may autonomously generate a load reduction bid. In one embodiment, the load reduction bid may be based on a cost function which models the customer's historic load reduction for given incentive prices. Further, a customer EMS unit 130 may determine not to generate a load reduction bid when, for example, cost function calculations indicate that load reduction would not be advantageous (i.e., profitable) for the customer.

With at least one load reduction bid from one or more customer nodes 130 published to the cloud 120, the incentive price range may be updated based on the received bids. Then, after a number of iterations, the bidding process may be designed to converge to an optimal incentive price that would best fulfill the demand response request. At that point, the optimal incentive price and aggregate load reduction commitments may be output to the utility provider 110.

In one embodiment, given the inventive price, λj(t), for a utility region, j, customer, i, may decide the optimal load reduction, xᵢ, that maximizes its profit. Specifically, given λj(t), each customer determines xᵢ by solving the following optimization problem,

$$\begin{matrix}Customer i ɛ {N}_{j} \text{:} & maximize & λ j ( t ) {x}_{i} - {c}_{i} ( {x}_{i} , t ) \\ & variable & {x}_{i}\end{matrix}$$

where cᵢ(xᵢ, t) is a cost function, or disutility function, experienced by customer i in reducing its power consumption by xᵢ. The cost function is time-varying because the discomfort experienced by customers who cannot run, for example, air conditioning, depends on variables such as outside temperature. As shown in FIG. 1, all customers participating in demand response may have their own EMS, and the customer EMS may know cᵢ(xᵢ, t) based on historical usage patterns and electricity bill payment information using, for example, machine learning or data mining methods.

Given the load reduction bids generated for the given incentive price, the updated incentive price may be generated. In an exemplary embodiment, the updated incentive price may be determined by a bisection function. The bisection function starts with the incentive price range, [λ_{j, min}, λ_{j, max}], which defines the searching range of the optimal incentive price. Initially, λ_{j, max} denotes the highest price the utility provider can afford and λ_{j, min}=0. At the k-th iteration, given λⱼ^{k}, xᵢ^{k}, (i.e., when the load reduction bids are collected), the new price λⱼ^{k+1} is computed as follows. If

$${\sum }_{i ɛ {N}_{j}} {x}_{i}^{k} > {D}_{j} ( t ) ,$$

the incentive price is higher than the optimal price so the committed load reduction, Dⱼ(t), is more than what is needed. Hence the incentive price should be reduced, and

λ_{j,max}=xᵢ^{k}.

### Similarly, if

$${\sum }_{i ɛ {N}_{j}} {x}_{i}^{k} < {D}_{j} ( t ) ,$$

the incentive price is lower than the optimal price so the committed load reduction is less than what is needed. Hence the incentive price should be increased, and

λ_{j,min}=xᵢ^{k}.

Then, the next incentive price is given by

λⱼ^{k+1}=λ_{j,max}+λ_{j,min}/2,

and the bidding process goes to the next iteration. Hence, at every iteration either λ_{j, min} or λ_{j, max} is updated and the searching space is reduced by half. The iterative bidding process will continue until the bisection function converges to the optimal incentive price, at which time the optimal incentive price and load reduction commitments may be reported to the utility provider. The utility provider may then use the commitments as a basis for executing demand response contracts with the bidding customers.

In one embodiment, a feasibility check may be used to determine whether cloud-based demand response is feasible. For example, after the first iteration of the bidding process there is a possibility that the function does not converge to the optimal point if Dj(t) is set too high or the initial λₘₐₓ is set too low, which implies that demand response will not work (i.e., the utility provider needs to buy power from the spot market). This condition is checked at the first iteration if λⱼ⁰ is set as λ_{j, max}; if Σxᵢ₎(λⱼ⁰)<Dⱼ(t), then the solution does not exist over [λ_{j, min}, λ_{j, max}] and the non-feasibility of demand response is immediately reported to the utility provider and the function stops.

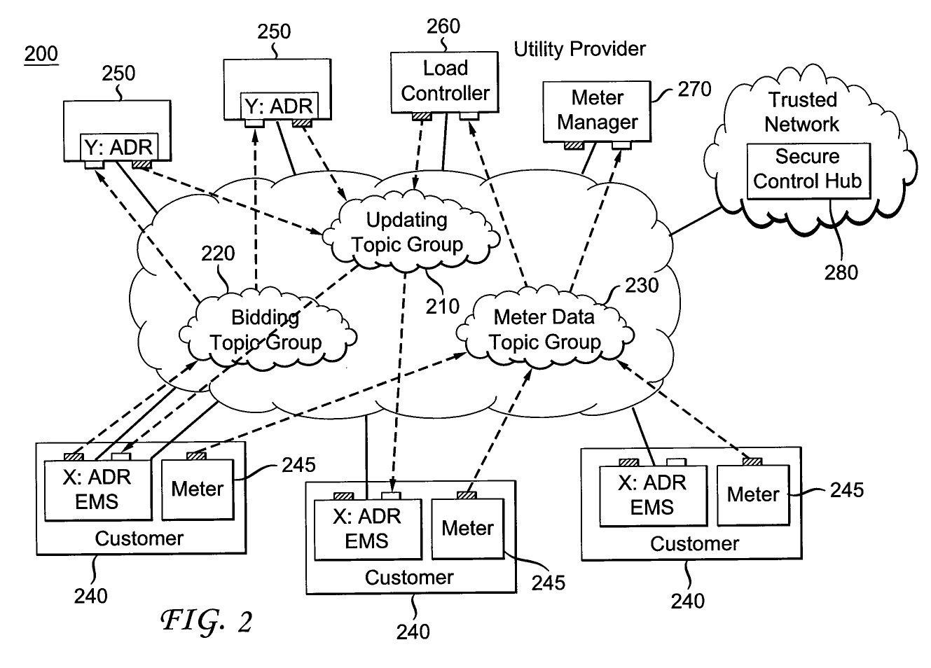

FIG. 2 is a diagram showing a more detailed view of a cloud computing environment that may be used for implementing DR transactions. In one embodiment, the cloud computing environment 200 may include various customer nodes 240, specialized nodes 250 and utility nodes 260 and 270. Further, the various functions of the environment 200 may be managed through a secure control hub 280 located, for example, on a remote trusted network connected to the cloud 200.

In one embodiment, the cloud computing environment 200 comprises a network based on data-centric communication. Unlike in the case of master/slave-based communication where data traffic is concentrated at a server, data-centric communication allows for data traffic to be dispersed throughout the cloud computing environment. As such, where customers are geographically concentrated, such as in an electric utility region, various computations may be done locally among customers. For example, the iterative computations for a load reduction bidding process may be implemented locally among the customers when a utility provider is located relatively far away from customers, or when a narrowband connection exists between the utility provider and customers. In one embodiment, the customer nodes may be connected in the cloud by a high-speed local area network (LAN), which may reduce latency by removing the needs of inspection in firewalls, which in turn would minimize queuing delays in the various routers of the LAN.

Data-centric communication may be implemented via a publisher-subscriber network configuration. For example, the publisher-subscriber network may comprise one or more network topic groups, or data-sharing nodes, that are accessible within the cloud computing environment 200. In one embodiment, the various network nodes may be adapted to publish data at a network topic group, or to subscribe to data from a network topic group, without reference to their location (e.g., IP address) or status. As such, the network topic groups may provide a degree of anonymity for data providers and receivers within the cloud 200.

In one embodiment, one or more data-sharing network topic groups may be established as accessible, centralized locations for DR transaction data. For example, the cloud computing environment 200 may include an updating topic group 220 for publishing initial and updated incentive prices. Likewise, a bidding topic group 210 may be included for publishing customer bids.

For example, each customer node 240 may access a utility provider's demand response request (i.e., initial incentive price range and load reduction magnitude) by subscribing to the updating topic group 210 at the initiation of a bidding process. The customer EMS 242 may then autonomously generate a load reduction bid based on the demand response request, and then have its bid published at the bidding topic group 220.

One or more nodes 250 adapted to calculate the updating function, Y, may subscribe to the bidding topic group 220 for access to the load reduction bids. When the bid information is obtained, these nodes 250 may then determine a new incentive price range, which may be published to the updating topic group 210 where it will be accessible for the next iteration of the bidding process. Alternatively, if an optimal incentive price has been reached via the convergence of updating function, Y, the optimal incentive price may be accessible to the utility provider through a subscription to the updating topic group 210.

In another embodiment, each customer node 240 may include a smart meter 245. The smart meter 245 may be adapted to make minute-scale reports for the utility provider, and for its own EMS unit 242 to manage the customer's cost function. For example, a customer EMS unit 242 may voluntarily and dynamically join a load reduction bidding process (e.g., at any point in the iterative process) based on meter data reported from the smart meter 245. As such, the cloud computing environment 200 may further comprise a meter-data topic group 230 for electricity usage data received from customer smart meters 245. For example, a utility provider's load controller 260 may be adapted to expect a power deficit aggregated for the utility region based on meter data acquired (via meter manager 270) from a subscription to the meter-data topic group 230.

In another embodiment of the environment 200, it may be desirable in various instances to randomly distribute the calculation of the updating function, Y. For example, the calculation of the updating function may be distributed to deter cyber attacks designed to tamper with the bidding process or deny service within the utility region. As such, in one embodiment the secure control hub 280 may be adapted to select one or more arbitrary nodes 250 for executing the updating function, Y. For example, the secure control hub 280 may randomly select the one or more arbitrary nodes 250 based on a hash function. In addition, the secure control hub 280 may be adapted to select arbitrary nodes 250 for calculating the updating function for an entire DR transaction or, in the alternative, for each iteration of the bidding process.

In one embodiment, the arbitrary nodes 250 may be non-bidding customer nodes or specialized computing nodes deployed within the utility region. In another embodiment, arbitrary nodes 250 may be deployed based on the scale of the utility region. For example, if the number of customers participating in the transaction is less than 100, a non-bidding customer node 240 may be selected to compute the updating function, Y. However, in some embodiments it may not be efficient for all of the customer nodes 240 to be adapted to compute the updating function, Y. For example, in some embodiments the customer EMS units 242 may not have enough computing power to compute the function, Y, or a large number of customers participating in the DR transaction may make the computation time for the updating function relatively long which, in emergency cases, may jeopardize the stability of the power grid. As such, specialized aggregation EMS units 250, separate from the customer EMS units 242 may be adapted to compute the updating function, Y. These specialized aggregation EMS units 250 may be stripped-down versions of customer EMS units 242. For example, the units 250 may be equipped with a combination of low-cycle CPUs, small-size memory, and economical communication interfaces.

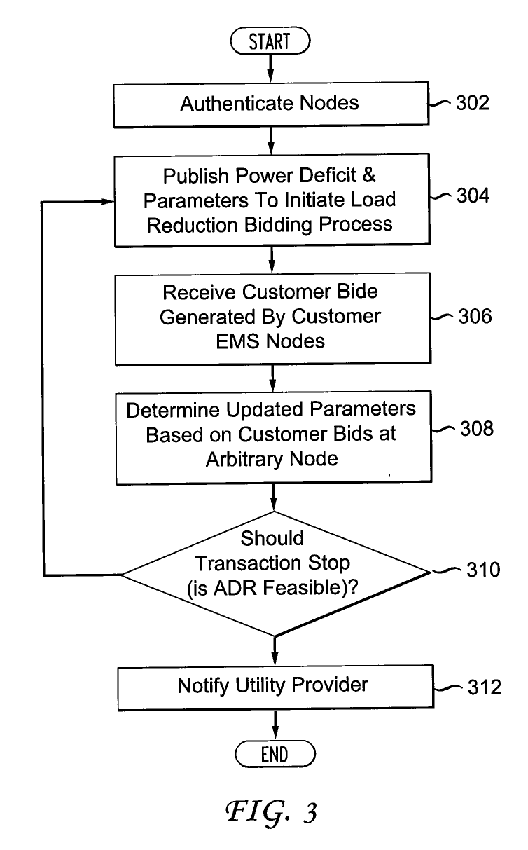

FIG. 3 is a flowchart showing the steps taken for implementing cloud-based demand response in a cloud computing environment. In one embodiment, the secure control hub 280 may include a node in communication with the cloud 200 for implementing one or more of the DR transaction steps. Alternatively, any combination of customer nodes 240, specialized nodes 250, and provider nodes 260 and 270 in communication with the cloud 200 may implement one or more of the various steps of the DR transaction.

At step 302, a node for implementing the DR transaction authenticates the various customer nodes 240, specialized nodes 250 and utility provider nodes 260 and 270. For example, it may be generally desirable to authenticate the various nodes prior to an DR transaction to prevent cyber attacks, or to lower the possibility of customer data being transmitted to unauthorized entities (e.g., the transmission of customer cost functions to the utility provider). As described in further detail below, the various nodes may be authenticated using various means, such as public-private key methods, group key methods and the like.

At step 304, the node publishes a demand response request from the utility provider to initiate a load reduction bidding process. For example, the demand response request may include a load reduction request, determined by the amount of power the utility provider needs to balance the supply and demand in the power grid, and an incentive price range. In one embodiment, the node may publish the demand response request at the updating topic group 220 to initiate a load reduction bidding process. Alternatively, the node may directly broadcast the demand response request to selected customer nodes 260, such as those authorized through authentication to participate in the DR transaction.

At step 306, the node receives at least one load reduction bid from participating customer nodes 240 in response to the published demand response request. For example, the node may receive the at least one load reduction bid by subscribing to the bidding topic group 210 where the bids may be aggregated. As noted, the customer nodes 240 may comprise EMS units 242 that may be adapted to autonomously generate load reduction bids based on a customer cost function.

When all of the load reduction bids are received for a given time window, the node determines updated bidding parameters based on, for example, a bisection function at step 308. The updated bidding parameters include the updated incentive price range for the demand response request. In one embodiment, the node may select one or more arbitrary nodes 250 for determining the updated bidding parameters. For example, the node may select the one or more arbitrary nodes 250 in a randomized fashion based on a hash function.

At step 310, the node determines whether the DR transaction should be stopped. In one embodiment, the node determines whether the DR transaction is feasible based on the first iteration of the bidding process. For example, the node may stop the bidding process when bids from the first iteration indicate that the bisection function will not converge toward an optimal incentive price, such as when the load reduction request is too high or the incentive price range is too low. If the node determines that the bidding process should be stopped, the node may, at step 312, immediately communicate to the utility provider the process was not successful, and that the demand response request should be fulfilled via the spot market.

If the DR transaction should continue, the method may then return to step 304 where the node publishes the updated incentive price, and steps 306 through 310 will be repeated for the next iteration of the bidding process. When the optimal incentive price is determined through, for example, the convergence of the bisection function, X, the node communicates the optimal incentive price to the utility load controller 260, such as by a securely managed transmission at step 312. Alternatively, the node may publish the optimal incentive price to a topic group 210 that is accessible to the utility load controller 260.

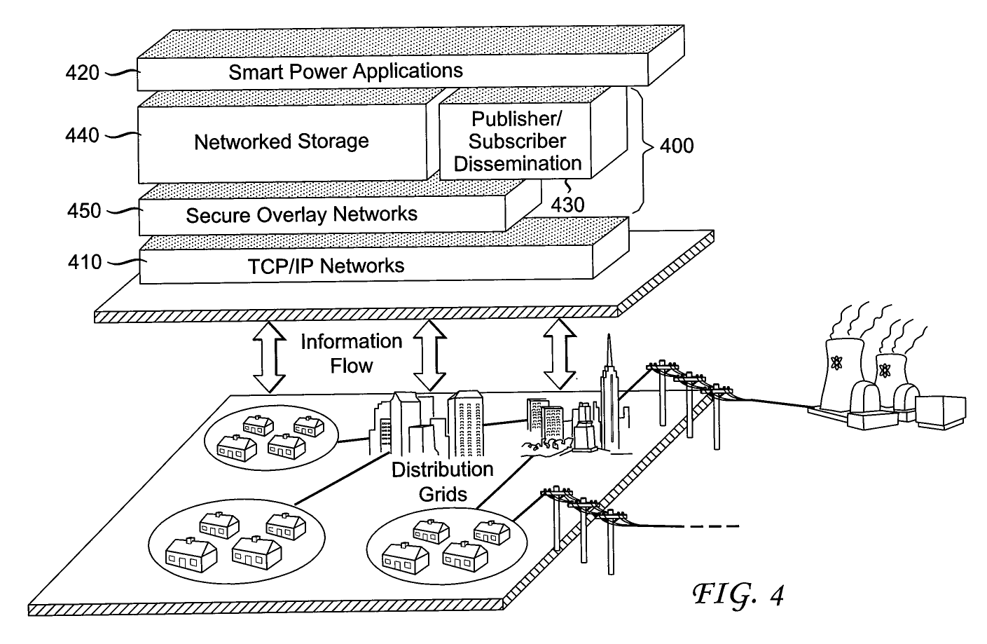

FIG. 4 is a high-level block diagram of network middleware that may be used for implementing cloud-based demand response. In one embodiment, the network middleware 400 resides between the IP network 410 and various smart power applications 420, such as smart metering and the like. The decentralization helps to minimize single-point-of-failure, while ensuring scalability. It can be extended to support reliability requirements such as self-healing (the ability to autonomously recover from any disturbances), and self-configurability (ability to autonomously use or recommend contingency options in the event of disturbances to the grid). The security framework in the overlay communication enables secure point-to-point and group communications.

In data-centric network middleware 400, a publisher-subscriber system 430 is used to deliver time-sensitive data as the information is generated. As compared with the master-slave communication, the following properties hold in general for the publisher-subscriber dissemination: (1) it enables the decoupling of information in terms of space, time and synchronization; (2) it is inherently distributed peer-to-peer, and enables multicasting; (3) it is highly scalable; (4) improved security due to the decoupling which in turn effectively prevents DDoS attack; and (5) there is no single point of failure and bottleneck. Publishers announce the availability of certain types of data, and subscribers announce their interests. The matching of the publisher and the subscriber for delivering data of particular interest can be made within the information middleware using, for example, a geographic hash table, and is a function of the grid overlay network.

Data-centric network middleware 400 may provide a networked storage system 440 that consists of an in-networked distributed buffer. This storage system may be cost-efficient and helps to mitigate storage and network bottlenecks. In one embodiment, the core of the in-networked and distributed storage is a hash function shared by all entities in the network. If the hash function allows any application to access the necessary data from the distributed storage units just-in-time, inordinate high-bandwidth transactions may be avoided.

In another embodiment, the secure control of the data-centric network middleware 400 may be implemented in one or more secure overlay networks 450 of trusted grid hub entities such as, for example, the secure control hub 280. For example, the hub entities might provide various control services such as the authentication of nodes at bootstrap time. As such, the hub entities may create and maintain secure multicast trees spanning over the potentially insecure IP cloud which carries the bulk of the data. Further, the hub entities may facilitate the security of multicast (and other) channels by authenticating and authorizing joins, such as for subscribers of topic groups, and provisioning users with the group keys. This allows fine-grained scalable control over the encryption of topics and ensures that the topics injected by the publishers are securely and efficiently delivered to the right group of subscribers. In one embodiment, communication in each publisher-subscriber group is secured by corresponding group keys. This use of encryption allows for multicast optimizations; trees may be safely merged, since subscribers would not possess the keys for unauthorized content. Due to the scale of the smart grid, nodes may not be connected directly to central servers. For example, intermediate-level nodes (between the servers and grid nodes) may perform multicast and aggregation functions as needed for reliability and effective maintenance. An intermediate-level node may be defined as a “super-node”. In various embodiments, a subset of grid nodes (e.g., meters 245) may assume super-node functions in addition to their own dedicated functions, thus constituting a scalable data overlay network. For example, a sub-set of super-nodes may be selected by the secure control hub 280 in a distributed manner.

In other embodiments, mutual authentication based on public key certificates (e.g., X.509 and certificate authority) may be necessary for preventing man-in-the-middle attacks. Hence, in various embodiments all nodes may have their own public-private key pair as well as a preconfigured public key of a certificate authority. Once each node is successfully authenticated, different tasks on the node can dynamically join distinct and multiple network topic groups such as the updating and bidding topic groups 210 and 220 and the meter-data topic group 230. In one embodiment, the network topic groups are created and managed by topic group managers, which may reside at the secure control hub 280, due to security considerations. For example, the secure control hub 280 may check the validity of each node intending to join a specific network topic group. As such, each valid node may communicate with other nodes within the specific topic group using the corresponding secret group keys given by the secure control hub 280.

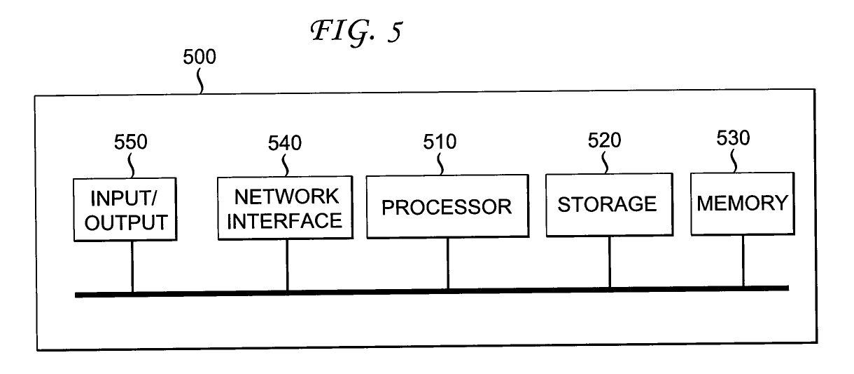

The above-described methods may be implemented on a computer using well-known computer processors, memory units, storage devices, computer software, and other components. A high-level block diagram of such a computer is illustrated in FIG. 5. Computer 500 contains a processor 510, which controls the overall operation of the computer 500 by executing computer program instructions which define such operation. The computer program instructions may be stored in a storage device 520 (e.g., magnetic disk) and loaded into memory 530 when execution of the computer program instructions is desired. Thus, the steps of the method of FIG. 3 may be defined by the computer program instructions stored in the memory 530 and/or storage 520 and controlled by the processor 510 executing the computer program instructions. The computer 500 may include one or more network interfaces 540 for communicating with other devices via a network for implementing the steps of the method of FIG. 3. The computer 500 may also include other input/output devices 550 that enable user interaction with the computer 500 (e.g., display, keyboard, mouse, speakers, buttons, etc.). One skilled in the art will recognize that an implementation of an actual computer could contain other components as well, and that FIG. 5 is a high level representation of some of the components of such a computer for illustrative purposes.

It has been observed, then, that a practical cloud-based demand response system may have certain desirable features such as being free of single point failures and bottlenecks; secure enough that messages used for pricing and bidding are difficult to compromise; scalable for a large number of customers; insensitive to parameter changes (e.g., number of customers, volume of load reduction, the failure of intermediate nodes, etc.); efficient in achieving participants' objectives; fast enough to be used on a very short time scale; and private enough to minimize the possibility of differential incentive pricing and other anti-competitive market practices.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

I claim:

1. A method comprising:
publishing an electric power demand response request at a communications node, the published demand response request including at least a load reduction request and an incentive price;
initiating a load reduction bidding process in response to the published demand response request, the load reduction bidding process being accessible to customer nodes; and
determining an updated incentive price based on at least one load reduction bid received from the customer nodes.

2. The method of claim 1, further comprising determining a time for stopping the load reduction bidding process based on the updated incentive price, wherein the updated incentive price at the time when the load reduction bidding process is stopped is the optimal incentive price.

3. The method of claim 2, further comprising transmitting the optimal incentive price to an electric utility provider.

4. The method of claim 1, further comprising publishing the updated incentive price.

5. The method of claim 1, further comprising determining whether the load reduction bidding process is feasible based on at least one load reduction bid.

6. The method of claim 1, wherein the updated incentive price is determined based on a bisection function.

7. The method of claim 1, further comprising selecting an arbitrary node for determining the updated incentive price, wherein the arbitrary node may be a customer node or a specialized computing node.

8. The method of claim 7, further comprising selecting the arbitrary node based on a hash function.

9. The method of claim 1, wherein the demand response request is based at least in part on electricity usage data collected from at least one customer node.

10. The method of claim 1, wherein the at least one load reduction bid is autonomously generated based on a customer cost function.

11. The method of claim 1, wherein the demand response request is determined by an electric utility provider and the customer nodes comprise an electric utility region.

12. A communications node comprising:
a control hub adapted to:
publish an electric power demand response request, the published demand response request including at least a load reduction request and an incentive price;
initiate a load reduction bidding process in response to the published demand response request, the load reduction bidding process being accessible to customer nodes; and
determine an updated incentive price based on at least one load reduction bid received from the customer nodes.

13. The communications node of claim 12, wherein the control hub is further adapted to determine a time for stopping the load reduction bidding process based on the updated incentive price, wherein the updated incentive price at the time when the load reduction bidding process is stopped is the optimal incentive price.

14. The communications node of claim 13, wherein the control hub is further adapted to transmit the optimal incentive price to the electric utility provider.

15. The communications node of claim 12, wherein the control hub is further adapted to publish the updated incentive price.

16. The communications node of claim 12, wherein the control hub is further adapted to determine whether the load reduction bidding process is feasible based on at least one load reduction bid.

17. The communications node of claim 12, wherein the control hub is further adapted to determine the updated incentive price based on a bisection function.

18. The communications node of claim 12, wherein the control hub is further adapted to select an arbitrary node for determining the updated incentive price, wherein the arbitrary node may be a customer node or a specialized computing node.

19. The communications node of claim 18, wherein the control hub is further adapted to select the arbitrary node based on a hash function.

20. An article of manufacture including a non-transitory computer-readable medium having instructions stored thereon, that in response to execution by a computing device causes the computing device to perform operations comprising:
publishing a demand response request from an electric utility provider at a node of a communications network, the published demand response request including at least a load reduction request and an incentive price;
initiating a load reduction bidding process in response to the published demand response request, the load reduction bidding process being accessible to customer nodes within a utility region; and
determining an updated incentive price based on at least one load reduction bid received from the customer nodes.

21. A customer node, comprising:
a smart meter adapted to monitor electric power usage by a customer and determine a customer cost function based on the monitored electrical power usage; and
an energy management system unit in communication with the smart meter, the energy management system unit adapted to generate a load reduction bid based on the customer cost function in response to a published load reduction bid request.

22. The customer node of claim 21, wherein the energy management system unit is further adapted to determine whether to generate a load reduction bid in response to a published load reduction bid request.

23. The customer node of claim 22, wherein the energy management system unit is further adapted to determine whether to generate a load reduction bid for each iteration of a load reduction bidding process.

24. A communications node, comprising:
an energy management system unit adapted to:
receive a signal indicating a selection to determine an updated incentive price for a load reduction bidding process;
receive load reduction bids generated based on a published demand response request for the load reduction bidding process; and
determine an updated incentive price based on the load reduction bids.

25. The communications node of claim 24, wherein the energy management system unit is further adapted to determine the updated incentive price based on a bisection function.

26. The communications node of claim 24, wherein the energy management system unit is further adapted to publish the updated incentive price.
